(19) United States
(12) Patent Application Publication
(10) Pub. No.: US 2025/0061563 A1
(43) Pub. Date: Feb. 20, 2025

(54) COMPUTER IMPLEMENTED METHOD FOR DEFECT DETECTION IN IMAGING DATASETS OF A PORTION OF AN OBJECT COMPRISING INTEGRATED CIRCUIT PATTERNS AND CORRESPONDING COMPUTER-READABLE MEDIUM, COMPUTER PROGRAM AND SYSTEM

(71) Applicant: Carl Zeiss SMT GmbH, Oberkochen (DE)

(72) Inventors: Bjoern Barz, Jena (DE); Alexander Freytag, Erfurt (DE); Bjoern Froehlich, Jena (DE); Bjoern Brauer, Magstadt (DE); Xuan Truong Nguyen, Berlin (DE)

(21) Appl. No.: 18/802,115

(22) Filed: Aug. 13, 2024

(30) Foreign Application Priority Data
Aug. 16, 2023 (DE) 102023121983.9

(51) Int. Cl. G06T 7/00

(52) U.S. Cl. CPC G06T 7/001; G06T 2207/20081; G06T 2207/20084; G06T 2207/20221; G06T 2207/30148

(57) ABSTRACT

The invention relates to a computer implemented method for defect detection, the method comprises: obtaining a first imaging dataset of a portion of an object comprising integrated circuit patterns; obtaining at least a second imaging dataset and a third imaging dataset comprising predominantly the same integrated circuit patterns as the portion of the object; and jointly processing at least the first imaging dataset, the second imaging dataset and the third imaging dataset to detect defects. The invention also relates to a corresponding computer program, computer-readable medium and system for defect detection.

### CROSS-REFERENCE TO RELATED APPLICATION

This application claims benefit under 35 U.S.C. § 119 (a) of German patent application 10 2023 121 983.9, filed on Aug. 16, 2023, which is incorporated herein by reference in its entirety.

### TECHNICAL FIELD

The invention relates to systems and methods for quality assurance of objects comprising integrated circuit patterns, more specifically to a computer implemented method, a computer-readable medium, a computer program product and a corresponding system for defect detection in an imaging dataset of such an object. By comparing the first imaging dataset to a second imaging dataset and a third imaging dataset defects can be detected. The method, computer-readable medium, computer program product and system can be utilized for quantitative metrology, process monitoring, defect detection and defect review in objects comprising integrated circuit patterns, e.g., in photolithography masks, reticles or wafers.

### BACKGROUND

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. One of the most crucial steps is the photolithography process.

Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., by use of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus variation, etc.

Photolithography mask inspection needs to be done at multiple points in time in order to improve the quality of the photolithography masks and to maximize their usage cycles. Once the photolithography mask is fabricated according to the requirements, an initial quality assessment of the photolithography mask is done at the mask house before it is shipped to the wafer fab. Semiconductor device design and photolithography mask manufacturing quality are verified by different procedures before the photolithography mask enters a semiconductor fabrication facility to begin production of integrated circuits. The semiconductor device design is checked by software simulation to verify that all features print correctly after photolithography in manufacturing. The photolithography mask is inspected for defects and measured to ensure that the features are within specification. The data gathered during this process becomes the golden baseline or reference for further inspections to be performed at the mask house or wafer fab. Any defects found on the photolithography mask are validated using a review tool followed by a decision of sending the photolithography mask for repair or decommissioning the mask and ordering a new one. At the wafer fab, the photolithography mask is scanned to find additional defects called “adders” compared to the last scan performed at the mask house. Each of these adders is analyzed using a review tool. In case of a particle defect, the particle is removed. In case of a pattern-based defect the photolithography mask is either repaired, if possible, or replaced by a new one. The inspection process is repeated after every few photolithography cycles.

Each defect in the photolithography mask can lead to unwanted behavior of the produced wafer, or a wafer can be significantly damaged. Therefore, each defect must be found and repaired if possible and necessary. Reliable and fast defect detection methods are, therefore, important for photolithography masks.

Apart from defect detection in photolithography masks, defect detection in wafers is also crucial for quality management. During the manufacturing of wavers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition etc. Therefore, a quality assurance process and a quality control process are important for ensuring high quality standards of the manufactured wafers.

Apart from quality assurance and quality control, defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus variation, etc., with different dies of the wafer being exposed to different manufacturing conditions. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment. Reliable and fast defect detection methods are, therefore, important for objects comprising integrated circuit patterns.

In order to analyze large amounts of data requiring large amounts of measurements to be taken, machine learning methods can be used. Machine learning is a field of artificial intelligence. Machine learning methods generally build a parametric machine learning model based on training data consisting of a large number of samples. After training, the method is able to generalize the knowledge gained from the training data to new previously unencountered samples, thereby making predictions for new data. There are many machine learning methods, e.g., linear regression, k-means, support vector machines, neural networks or deep learning approaches.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional or pooling layers.

Methods for the automatic detection of defects in objects comprising integrated circuit patterns include defect detection algorithms, which are often based on a die-to-die or die-to-database principle.

The die-to-die principle compares an imaging dataset of portions of an object with a reference dataset of the same portions of another identical object or of the same object. The discovered deviations are treated as defects.

The die-to-database principle compares an imaging dataset of an object with a simulated reference dataset or a design, e.g., a CAD file, thereby discovering deviations from the ideal data.

For example, the US 2019/0130551 A1 discloses a die-to-die method for defect detection. In a first step, a reference dataset is generated from a number of scan images of an identical wafer, e.g., by a median filter. Imaging datasets are obtained from a target wafer and defects are detected based on pixel value differences of an imaging dataset and the reference dataset.

Both die-to-die or die-to-database approaches, rely on a comparison of an imaging dataset to a reference dataset, e.g., an acquired imaging dataset or a simulated or design dataset. Depending on the quality of the datasets to be compared, e.g., on the noise level or the similarity of the appearance of design datasets and imaging datasets, defects can be missed or false positive defect detections can occur.

To improve the accuracy of the defect detection, the US 20060204109 A1 discloses a method for the detection of defects in a plurality of images having essentially the same image contents. In a first step, differences are computed between pairs of images. By comparing the pairwise differences, defects are detected in a second step. However, computing pairwise differences and comparing them is time-consuming, especially for large datasets such as those obtained from objects comprising integrated circuit patterns. In addition, the results of the subsequent comparisons can be ambiguous in case one comparison results in a defect but another does not.

It is, therefore, an aspect of the invention to detect defects in objects comprising integrated circuit patterns with high recall and precision. It is another aspect of the invention to improve the accuracy of the detected defects. It is another aspect of the invention to obtain low runtimes and a high throughput of the defect detection method. Another aspect of the invention is to provide methods for defect detection that do not require expert knowledge of users.

The aspects are achieved by the invention specified in the independent claims. Advantageous embodiments and further developments of the invention are specified in the dependent claims.

### SUMMARY

Embodiments of the invention concern computer implemented methods, computer-readable media and systems implementing defect detection methods for objects comprising integrated circuit patterns.

An integrated circuit pattern can, for example, comprise semiconductor structures. An object comprising integrated circuit patterns can refer, for example, to a photolithography mask, a reticle or a wafer. In a photolithography mask or reticle the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

The object comprising integrated circuit patterns may be a photolithography mask. The photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

An embodiment of the invention involves a computer implemented method for defect detection comprising: obtaining a first imaging dataset of a portion of an object comprising integrated circuit patterns; obtaining at least a second imaging dataset and a third imaging dataset comprising predominantly the same integrated circuit patterns as the portion of the object; and jointly processing at least the first imaging dataset, the second imaging dataset and the third imaging dataset to detect defects. Further imaging datasets, for example, a fourth imaging dataset, or a fourth imaging dataset and a fifth imaging dataset, can be used to increase the precision and recall of the defect detection method and the accuracy of the detected defects. Further imaging datasets can, for example, be used depending on the difficulty of the defect detection task.

By using at least three imaging datasets instead of only an imaging dataset and a reference dataset, the precision and recall of the defect detection method is improved due to the additional information available. For example, the robustness with respect to noise can be improved in this way. Furthermore, the ambiguity generated by two or more separate comparisons of different input datasets is reduced by considering all input datasets jointly. Thus, the recall and precision of the defect detection method and the accuracy of the detected defects is improved. In addition, the use of three or more imaging datasets allows for the detection of defects in all imaging datasets, for example in case an acquired imaging dataset presumably without defects (so-called golden reference) is used that nevertheless contains defects. With respect to defect detection methods that carry out pairwise comparisons between each two imaging datasets, the runtime is reduced, since each imaging dataset is only considered once by the defect detection method. In this way, the throughput is increased.

The term “defect” refers to a localized deviation of an integrated circuit pattern from an a priori defined norm of the integrated circuit pattern. For instance, a defect of an integrated circuit pattern, e.g., of a semiconductor structure, can result in malfunctioning of an associated semiconductor device. Depending on the detected defect, for example, the photolithography process can be improved, or photolithography masks or wafers can be repaired or discarded. The norm of the integrated circuit pattern can be defined by one or more corresponding reference objects or reference datasets, e.g., by design datasets, simulated datasets or acquired defect-free datasets.

A portion of an object can refer to a part of the object, e.g., one or more areas of the object that can be connected but do not have to, or to the whole object.

According to the techniques described herein, various imaging modalities may be used to acquire one or more of the imaging datasets (the first imaging dataset, the second imaging dataset, the third imaging dataset and, potentially, further imaging datasets) for the detection of defects. An imaging dataset can comprise one or more single-channel images or multi-channel images, e.g., focus stacks. For instance, it is possible that the imaging dataset includes one or more 2-D images. It is possible to employ a multi beam scanning electron microscope (mSEM). mSEM employs multiple beams to acquire contemporaneously images in multiple fields of view. For instance, a number of not less than 50 beams could be used or even not less than 90 beams. Each beam covers a separate portion of a surface of the object comprising integrated circuit patterns. Thereby, a large imaging dataset is acquired within a short duration of time.

Typically, 4.5 gigapixels are acquired per second using contemporary machines. For illustration, one square centimeter of a wafer can be imaged with 2 nm pixel size leading to 25 terapixel of data. Other examples for imaging datasets including 2D images would relate to imaging modalities such as optical imaging, phase-contrast imaging, x-ray imaging, etc. It would also be possible that one or more of the imaging datasets are volumetric 3-D datasets, which can be processed slice-by-slice or as a three-dimensional volume. Here, a crossbeam imaging device including a focused-ion beam (FIB) source, an atomic force microscope (AFM) or a scanning electron microscope (SEM) could be used. Multimodal imaging datasets may be used, e.g., a combination of x-ray imaging and SEM. An imaging dataset can comprise one or more aerial images acquired by an aerial imaging system. An aerial image is the radiation intensity distribution at substrate level. It can be used to simulate the radiation intensity distribution generated by a photolithography mask during the photolithography process. The aerial image measurement system can, for example, be equipped with a staring array sensor or a line-scanning sensor or a time-delayed integration (TDI) sensor. For example, the sensor can include an array of sensing elements or pixels.

An imaging dataset can also be obtained by acquiring images of a reference object comprising integrated circuit patterns. The reference object comprising integrated circuit patterns can, for example, be another instance of the same type of object, or it can be of a different type but comprising at least a portion of the same integrated circuit patterns as the object. The imaging dataset can also be obtained from one or more portions of the (same) object comprising integrated circuit patterns, e.g., from another die of the object, for example in case of repetitive structures, or of the same die at a different time, e.g., previously acquired imaging datasets. Alternatively, the imaging dataset can be artificially generated.

One or more of the imaging datasets (the first imaging dataset, the second imaging dataset, the third imaging dataset and, potentially, further imaging datasets) can be artificially generated datasets, e.g., a simulated dataset or a design dataset. In an example, a simulated dataset of the object comprising integrated circuit patterns is obtained by use of rigorous physical simulations of the electromagnetic wave propagation process within the photolithography mask such as finite difference time domain (FDTD) or rigorous coupled wave analysis (RWCA). A simulated dataset can also be obtained using approximations of the wave propagation process such as the thin element approximation (TEA) or Kirchhoff approach under the assumption of a thin photolithography mask. A simulated dataset can also be obtained using machine learning models that are trained to simulate the wave propagation process, e.g., by using pairs of photolithography mask descriptions and corresponding aerial images. An imaging dataset can also be obtained from a design file such as a CAD file, e.g., by extracting polygons from the design file. The appearance of an artificially generated imaging dataset, e.g., of a design dataset or a simulated imaging dataset, can be modified to resemble the appearance of an acquired imaging dataset, e.g., by use of machine learning. For example, a generative adversarial neural network comprising a generator and a discriminator can be trained such that the generator learns to mimic the appearance of an acquired imaging dataset, while the discriminator learns to discriminate between “real” acquired imaging datasets and artificially generated imaging datasets with modified appearance. After training, the generator can be used to modify the appearance of artificially generated imaging datasets.

One or more of the imaging datasets (the first imaging dataset, the second imaging dataset, the third imaging dataset and, potentially, further imaging datasets) can be acquired using some imaging system as described above. One or more of the imaging datasets can be loaded from a database or a memory or a cloud storage.

One or more of the imaging datasets are, preferably, essentially defect-free, comprising none or only few defects (i.e., less than 10%, preferably less than 5% of an imaging dataset comprises a defect).

At least the second imaging dataset and the third imaging dataset comprise predominantly the same integrated circuit patterns as the portion of the object. Predominantly means that at least 50%, preferably at least 75%, more preferably at least 90%, most preferably at least 95% of the integrated circuit patterns of the second imaging dataset and the third imaging dataset are the same as the integrated circuit patterns of the portion of the object. In a preferred embodiment, the second imaging dataset and the third imaging dataset comprise the same integrated circuit patterns as the portion of the object.

At least the first imaging dataset, the second imaging dataset and the third imaging dataset are processed jointly to detect defects. A method that jointly processes at least the first imaging dataset, the second imaging dataset and the third imaging dataset to detect defects derives defect information by comparing data directly obtained from at least the first imaging dataset, the second imaging dataset and the third imaging dataset. Thus, the first imaging dataset, the second imaging dataset and the third imaging dataset are directly processed in a single step of the defect detection method. They are processed simultaneously. In contrast, a method that does not jointly process the input datasets, for example sequentially processes only a subset of the input datasets to obtain intermediate defect detection results, e.g., by applying the same subroutine to different subsets of the input datasets, and fuses the intermediate results in the end, e.g., by combining, selecting or filtering the detected defects. For example, a method for defect detection that does not jointly process the input datasets detects intermediate defects by comparing the first imaging dataset to the second imaging dataset followed by detecting intermediate defects by comparing the first imaging dataset to the third imaging dataset and/or followed by detecting intermediate defects by comparing the second imaging dataset to the third imaging dataset, and a computation of the final defect detection by combining the intermediate defect detections.

The first imaging dataset, the second imaging dataset and the third imaging dataset can be pre-processed before applying the defect detection method. Pre-processing refers to any kind of processing of an input dataset that improves, simplifies or speeds up a subsequent defect detection method. Pre-processing is not a mandatory step of a method, it is always optional as it only serves to improve the input dataset. Thus, pre-processing steps can be skipped without affecting the functionality of the defect detection method. For example, pre-processing comprises registration of the input datasets to align them before defect detection, thereby simplifying the comparison of the input datasets and improving the defect detection results. For example, pre-processing comprises filters that can be applied to the first imaging dataset and/or the second imaging dataset and/or the third imaging dataset, e.g., contrast or brightness modifying filters, edge detectors, feature extractors, etc. In an example, pre-processing refers to any kind of processing that improves, simplifies or speeds up a subsequent defect detection method and that does not make use of the other input datasets.

According to an example, the processing comprises estimating one or more defect indicators, and defects are detected using the one or more defect indicators. A defect indicator comprises information about properties of a potential defect, e.g., about the location, the appearance, the shape, the presence of the defect, the imaging dataset that comprises the defect or about measurements of the defect. In this way, potential defects can be easily characterized, filtered, compared and evaluated in order to detect defects.

In an example, at least one defect indicator can comprise a pixel-wise map or a voxel-wise map, e.g., a segmentation map, a probability map, a confidence map, etc. By using pixel-wise maps or voxel-wise maps highly localized information can be derived for the defects. In addition, pixel-wise maps or voxel-wise maps can be easily compared and processed with other pixel-wise maps or voxel-wise maps. Voxel-wise maps are, in particular, of interest in case of 3D input datasets.

In an example, at least one defect indicator can comprise a list of defect descriptions, e.g., bounding boxes, contours, coordinates, measurements, etc. Lists of defect descriptions can be used in case pixel-wise information is not required or not available. Thus, memory space and computation time is saved.

In an example, at least one defect indicator is a probabilistic defect indicator. A probabilistic defect indicator comprises probabilistic information about defects. Probabilistic information can, for example, comprise probability values or probability distributions, e.g., over properties of the defect such as intensity or color or location, or moments of probability distributions, e.g., a mean value or variance or higher order moment of a probability distribution. By using a probabilistic defect indicator, a measure for uncertainty is incorporated in the defect indicator. Uncertainty measures can be used to make more qualified decisions on the presence or absence of a defect, e.g., by using additional information such as location, size, shape, etc. They are also useful for further processing routines, e.g., for routines that combine different defect indicators to decide on the presence of a defect. In this way, the precision and recall of the defect detection is improved.

In an example, at least one defect indicator comprises a defect and a unique identifier of an imaging dataset that contains the defect. The defect indicator, thus, contains information on defects and on the imaging datasets the defects originate from. The unique identifier can, for example, refer to a number, e.g., a “1” for the first imaging dataset, a “2” for the second imaging dataset, a “3” for the third imaging dataset, etc. Thus, using the one or more defect indicators, the imaging datasets the defects originate from can be identified. In this way, the defects can be localized in the imaging datasets. In addition, defects can be detected with increased accuracy, since information on the originating dataset can be used to define the likelihood of a defect being present or not.

The defect detection method can yield a single defect indicator, or it can yield multiple defect indicators. According to an aspect of the invention, a defect indicator is obtained for at least each of the first imaging dataset, the second imaging dataset and the third imaging dataset. The defect indicators can be of the same type or of different types, that is pixel-wise maps or lists of defect descriptions or combinations thereof. Defects can then be detected by comparing at least the defect indicators for the first imaging dataset, the second imaging dataset and the third imaging dataset. For example, defect indicators appearing only in one of the at least three imaging datasets indicate the presence of a defect. Defect indicators appearing in two or more of the at least three imaging datasets indicate artifacts or nuisances such as rounded edges, line roughness, etc. that do not indicate a defect but commonly occur in acquired imaging datasets. A defect indictor in a presumably defect-free imaging dataset that is not present in the at least two other imaging datasets can indicate a defect in the presumably defect-free imaging dataset. By using a defect indicator for at least each of the first imaging dataset, the second imaging dataset and the third imaging dataset, more qualified decisions on the presence of defects can be taken. For example, rare defects can be found in imaging datasets that are usually defect-free, e.g., in golden reference datasets. These locations can be ignored when detecting defects in the first imaging dataset, thereby reducing false positives and improving the precision of the defect detection method and the accuracy of the detected defects. In another example, the regularity of the integrated circuit patterns of an imaging dataset can be examined, and irregular integrated circuit patterns can be ignored when detecting defects in the imaging dataset, thereby reducing false positives and improving the precision of the defect detection method and the accuracy of the detected defects. In another example, in case the defect indicators show no defect in two of the imaging datasets, but a defect is likely present in the other imaging dataset, then the likelihood for a defect is increased. In this way, false negatives can be prevented and the recall of the defect detection method and the accuracy of the detected defects is improved.

According to an aspect of the invention, at least the first imaging dataset, the second imaging dataset and the third imaging dataset are registered. Registration is the process of transforming different datasets into one coordinate system. For example, the first imaging dataset and the third imaging dataset can be transformed into the coordinate system of the second imaging dataset, or the first imaging dataset and the second imaging dataset can be transformed into the coordinate system of the third imaging dataset, or the second imaging dataset and the third imaging dataset are transformed into the coordinate system of the first imaging dataset. Alternatively, the first imaging dataset, the second imaging dataset and the third imaging dataset are transformed into another coordinate system. Registration of at least the first imaging dataset, the second imaging dataset and the third imaging dataset can be carried out as a pre-processing step before applying the defect detection method. By registering the first imaging dataset, the second imaging dataset and the third imaging dataset, corresponding integrated circuit patterns can be found at the same coordinates and can be compared more easily and accurately. Thus, the recall and precision of the defect detection method and the accuracy of the detected defects is improved.

In an example, the processing comprises evaluating the likelihood of defects from properties of the layout of the integrated circuit patterns in the portion of the object, e.g., by evaluating the regularity of the integrated circuit patterns. In case of an irregular pattern in an imaging dataset, the probability for a defect is increased, whereas in case of a regular pattern the probability for a defect is decreased. The resulting defect probability map can be used as a separate defect indicator, or it can be used to modify another defect indicator.

In a preferred example of the invention, at least the first imaging dataset, the second imaging dataset and the third imaging dataset are input datasets of a machine learning model. Machine learning methods have several advantages. Firstly, the machine learning model is trained using training data comprising samples. Thus, the user does not have to devise suboptimal decision rules or mappings himself. Instead, the machine learning model learns in a data-driven way the complex interrelationships between input data and desired output data. Thus, the application is simplified for the user, and even non-expert users can train the machine learning model. In addition, the mapping between the input data and the output data is optimal with respect to predefined criteria expressed in the loss function. Therefore, the precision and recall of the defect detection method and the accuracy of the detected defects is improved. Furthermore, the machine learning model can be easily adapted in case the input datasets change over time. In addition, even though the training may take some time, the application of a machine learning model to input data, i.e., a forward pass, can be parallelized using GPUs and is very fast, thereby reducing runtime and increasing the throughput of the defect detection method.

Using a machine learning model, the inputs can be processed jointly. In an example, the machine learning model comprises a neural network with at least three input paths, wherein the first imaging dataset is processed along a first input path, the second imaging dataset is processed along a second input path and the third imaging dataset is processed along a third input path. An input path refers to a sequence of layers of a neural network that processes only information of one of the input datasets. Each input dataset can be directly processed in the input path, or it can be pre-processed before applying the machine learning model. The first imaging dataset, the second imaging dataset and the third imaging dataset are processed independently of one another in separate input paths. By using separate input paths for the input datasets, each input dataset can be individually processed using different processing steps in the input path to derive input dataset specific information relevant for defect detection. In this way, very different types of input datasets can be used in the same machine learning model, e.g., acquired imaging datasets, simulated datasets, design datasets and/or imaging datasets of different modalities, e.g., SEM, AFM, simulated SEM, etc. Alternatively, each input dataset can be processed using the same processing steps in the input path by having the same layers and the same weights in each input path. In this way, consistent processing is ensured independent of the input path an imaging dataset is fed into.

In a preferred example, the at least three input paths merge in a single merging layer. By merging the three input paths in a single merging layer, the information of the input paths is combined or fused in the merging layer, e.g., by stacking the intermediate processing results. From the merging layer onwards, the information obtained from the three input datasets is processed together simultaneously. The machine learning model contains at least one step that derives defect information by comparing data directly obtained from at least the first imaging dataset, the second imaging dataset and the third imaging dataset. Thus, the first imaging dataset, the second imaging dataset and the third imaging dataset are processed jointly. As information from all input datasets is available for defect detection at the same time (instead of sequentially), the recall and precision of the defect detection method and the accuracy of the detected defects is improved.

In an example, the neural network generates a defect indicator for at least each of the first imaging dataset, the second imaging dataset and the third imaging dataset. By generating two or more defect indicators, defect information specific to the input datasets can be generated. In this way, defects or potential defect locations or potential false positive defect locations can be identified and used to improve the defect detection in the imaging datasets. The three or more defect indicators can be combined to generate a more accurate defect detection result in order to improve recall and precision of the defect detection method and the accuracy of the detected defects.

According to an aspect of the invention, the neural network comprises at least three output paths, wherein each defect indicator is generated by a different output path. In this way, a defect indicator for at least each of the first imaging dataset, the second imaging dataset and the third imaging dataset is generated. Each input path of the neural network corresponds to an output path of the neural network, wherein the corresponding output path generates the defect indicator for the input dataset that is processed by the input path. By generating different defect indicators, input dataset specific defect information can be generated, that can be used to improve the precision and recall of the defect detection method and the accuracy of the detected defects.

In an example, the neural network comprises skip connections each configured to connect a layer of an input path with a layer of an output path. In particular, each skip connection connects a layer of an input path with a layer of a corresponding output path. In this way, the skip connections can be used to directly access information of the layers of the input paths from layers of the output paths, in particular from layers of the corresponding output paths. Thus, input dataset specific information can be used in the output paths in addition to the jointly processed information to generate the defect indicators. In this way, the precision and recall of the defect detection method and the accuracy of the detected defects is improved. The neural network can comprise further skip connections between other layers as well.

According to an aspect of the invention, the machine learning model is configured to process the input paths asynchronously. Asynchronously means that the processing of an input path can start as soon as the corresponding input dataset is available without waiting for the availability of the other input datasets. Since an input path does not depend on the other input datasets, computation time and computation resources can be saved by processing the input paths upon availability of the input datasets. The joint part of the neural network can then be processed after the results of all input paths are available.

In an example, the first imaging dataset, the second imaging dataset and the third imaging dataset are registered using an additional machine learning model. The additional machine learning model can be trained to register the input datasets. Registration refers to the process of transforming different imaging datasets into one coordinate system, e.g., a coordinate system of one of the at least three imaging datasets. The additional machine learning model can, for example, use the at least three imaging datasets as input and map them to at least two transformation vector fields that indicate the pixel shift for transforming at least two of the imaging datasets into the coordinate system of the third imaging dataset. Alternatively, the machine learning model maps to at least three transformation vector fields that indicate the pixel shift for transforming all of the at least three imaging datasets into the same coordinate system. A convolutional neural network, a U-Net or a transformer-based machine learning model can, for example, be used as machine learning model. The machine learning model can be trained by minimizing a loss function that comprises the deviation of the pixel values between the at least three imaging datasets after applying the estimated transformation vector fields (“warping error”). It can be integrated as a pre-processing step into the neural network architecture. By registering the input datasets, corresponding integrated circuit patterns are located in the same location within each input dataset. Thus, comparing the imaged integrated circuit patterns is simplified and, thus, more accurate. Therefore, the precision and recall of the defect detection method and the accuracy of the detected defects is improved.

In an example, at least one imaging dataset comprises additional information on the likelihood of a defect being present within the imaging dataset. The likelihood of a defect being present in the imaging dataset can, for example, be derived from the generation method of the imaging dataset. The generation method refers to the way the imaging dataset is generated, e.g., by acquisition using a machine, from a golden reference object that has been checked for defects, or by simulation from a model that is defect-free. A likelihood for defects can be associated with a generation method. Defect indicators in imaging datasets with lower defect likelihood are less likely to indicate the presence of a defect. This kind of information can be used in the defect detection in order to decide on the presence of a defect or not. In this way, the precision and recall of the defect detection method and the accuracy of the detected defects can be improved.

According to an embodiment of the invention, a computer implemented method for training a machine learning model for defect detection according to any of the embodiments, examples or aspects described above comprises: providing training images of objects comprising integrated circuit patterns, the training images comprising at least triplets of first imaging datasets, second imaging datasets and third imaging datasets including annotated defects; and training the machine learning model using the provided training images by minimizing a loss function configured for defect detection. The loss function can comprise a cross-entropy loss function and/or a focal loss function, etc. to compare the defect indicators or the detected defects to the annotated defects.

A computer program according to an embodiment of the invention comprises instructions which, when the program is executed by a computer, cause the computer to carry out a method of any one of the embodiments, examples or aspects described above.

A computer-readable medium according to an embodiment of the invention has stored thereon a computer program executable by a computing device, the computer program comprising code for executing a method of any one of the embodiments, examples or aspects described above.

A system for defect detection according to an embodiment of the invention comprises: an imaging device configured to provide one or more imaging datasets of a portion of an object comprising integrated circuit patterns; one or more processing devices; and one or more machine-readable hardware storage devices comprising instructions that are executable by one or more processing devices to apply a method for defect detection according to any one of the embodiments, examples or aspects described above.

The invention described by examples and embodiments is not limited to the embodiments and examples but can be implemented by those skilled in the art by various combinations or modifications thereof.

### BRIEF DESCRIPTION OF THE DRAWINGS

FIG. 1 illustrates an exemplary transmission-based photolithography system, e.g., a deep ultraviolet (DUV) photolithography system;

FIG. 2 illustrates an exemplary reflection-based photolithography system, e.g., an extreme ultraviolet (EUV) photolithography system;

FIG. 3 shows a first imaging dataset of an object comprising integrated circuit patterns in the form of a photolithography mask comprising a defect;

FIG. 4 illustrates a flowchart of a computer implemented method for defect detection according to an embodiment of the invention;

FIGS. 5 and 6 illustrate examples of the computer implemented method for defect detection according to an embodiment of the invention;

FIG. 7 illustrates a machine learning model in the form of a neural network that jointly processes the first imaging dataset, the second imaging dataset and the third imaging dataset;

FIG. 8 illustrates a machine learning model in the form of a neural network that jointly processes the first imaging dataset, the second imaging dataset and the third imaging dataset and includes multiple output paths and skip connections;

FIG. 9 illustrates a flowchart of a computer implemented method for training a machine learning model for defect detection according to an embodiment of the invention; and

FIG. 10 illustrates a system for defect detection according to an embodiment of the invention.

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

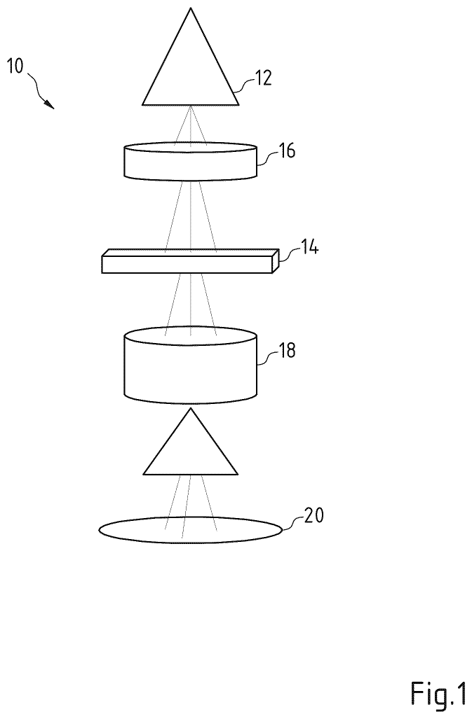

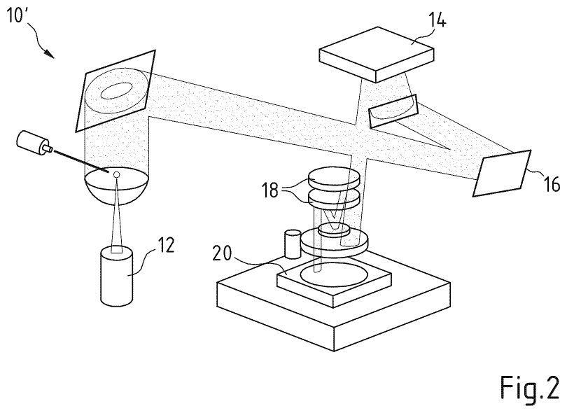

The methods described herein can be used, for example, with transmission-based photolithography systems 10 or reflection-based photolithography systems 10′ as shown in FIGS. 1 and 2.

FIG. 1 illustrates an exemplary transmission-based photolithography system 10, e.g., a DUV photolithography system. Major components are a light source 12, which may be a deep-ultraviolet (DUV) excimer laser source, imaging optics which, for example, may include optics that shape radiation from the light source 12, a photolithography mask 14, illumination optics 16 that illuminate the photolithography mask 14 and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

In the present document, the terms “radiation” or “beam” are used to encompass all types of electromagnetic radiation, including ultraviolet radiation (e.g., with a wavelength of 365, 248, 193, 157 or 126 nm) and EUV (extreme ultra-violet radiation, e.g. having a wavelength in the range of about 3-100 nm).

Illumination optics 16 may include optical components for shaping, adjusting and/or projecting radiation from the light source 12 before the radiation passes the photolithography mask 14. Projection optics 18 may include optical components for shaping, adjusting and/or projecting the radiation after the radiation passes the photolithography mask 14. The illumination optics 16 exclude the light source 12, the projection optics exclude the photolithography mask 14.

Illumination optics 16 and projection optics 18 may comprise various types of optical systems, including refractive optics, reflective optics, apertures and catadioptric optics, for example. Illumination optics 16 and projection optics 18 may also include components operating according to any of these design types for directing, shaping or controlling the projection beam of radiation, collectively or singularly.

FIG. 2 illustrates an exemplary reflection-based photolithography system 10′, e.g., an extreme ultraviolet light (EUV) photolithography system 10′. Major components are a light source 12, which may be a laser plasma light source, illumination optics 16 which, for example, may include optics that shape radiation from the light source 12, a photolithography mask 14, and projection optics 18 that project an image of the photolithography mask pattern onto a photoresist layer of a wafer 20. An adjustable filter or aperture at the pupil plane of the projection optics 18 may restrict the range of beam angles that impinge on the wafer 20.

The production of objects comprising integrated circuit patterns such as photolithography masks and wafers requires great care due to the small structure sizes of the integrated circuit patterns. Defects cannot be prevented but can lead to the malfunctioning of semiconductor devices. Therefore, an accurate and fast method for defect detection in objects comprising integrated circuit patterns is required for quality control.

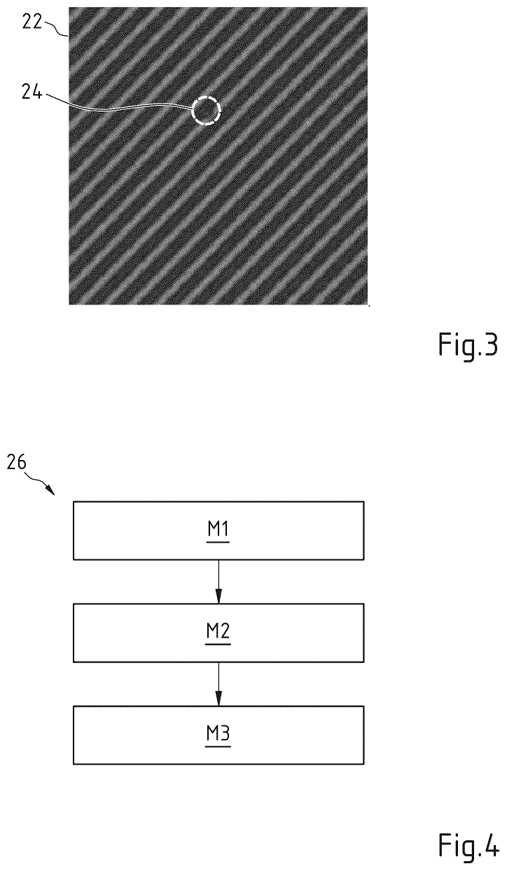

FIG. 3 shows a first imaging dataset 22 of an object comprising integrated circuit patterns in the form of a photolithography mask 14 comprising a defect 24. Methods known from the art often use die-to-die or die-to-database methods to detect such defects 24. Die-to-die methods compare a portion of the first imaging dataset 22 to another portion of the same or a different first imaging dataset 22 to detect defects 24. Die-to-database methods provide an artificial reference dataset, e.g., a design dataset or a simulated dataset, that is compared to the first imaging dataset 22 of the object comprising integrated circuit patterns. The recall and precision of the defect detection method and the accuracy of the detected defects depend on the quality of the reference dataset, e.g., on the noise level, on the accuracy of the structures, on the alignment of the reference dataset and the first imaging dataset 22, etc. It is, therefore, important to prevent false negative and false positive defect detections.

By using three or more imaging datasets, the additional information can be used to take a more qualified decision on the presence of defects. However, known methods that use three or more imaging datasets usually rely on pairwise comparisons of the first imaging dataset 22 and each other imaging dataset. This process is suboptimal since the available information is only considered sequentially and since it can lead to ambiguities in case contradictory results are obtained from the two or more comparisons. In addition, the computation time increases with the number of imaging datasets. It is, therefore, an aspect of the invention to improve recall and precision of the defect detection method and the accuracy of the detected defects, while still achieving low runtimes and high throughput of the defect detection method.

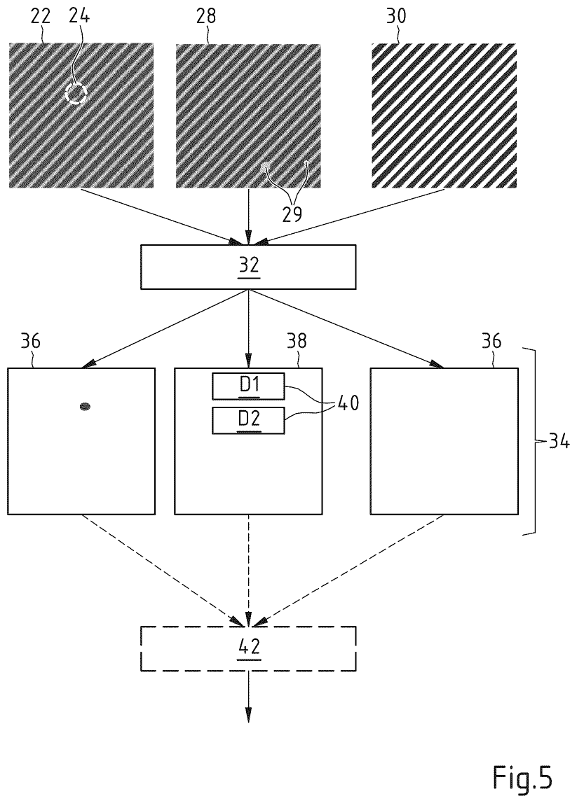

FIG. 4 illustrates a flowchart of a computer implemented method 26 for defect detection according to an embodiment of the invention. The method comprises the following steps: obtaining a first imaging dataset of a portion of an object comprising integrated circuit patterns in a step M1; obtaining at least a second imaging dataset and a third imaging dataset comprising predominantly the same integrated circuit patterns as the portion of the object in a step M2; jointly processing at least the first imaging dataset, the second imaging dataset and the third imaging dataset to detect defects in a step M3.

By using at least the first imaging dataset 22, the second imaging dataset and the third imaging dataset, additional information is available for defect detection, thereby improving recall and precision of the defect detection method and the accuracy of the detected defects. Instead of carrying out sequential pairwise comparisons, e.g., by comparing the first imaging dataset 22 to the second imaging dataset followed by a comparison of the first imaging dataset 22 to the third imaging dataset, at least the first imaging dataset 22, the second imaging dataset and the third imaging dataset are processed jointly. In this way, computation time is saved and the throughput increased. Furthermore, jointly considering information from the first imaging dataset 22, the second imaging dataset and the third imaging dataset allows for taking a more qualified decision on the presence of a defect. In addition, defects can be detected in each of the imaging datasets, in particular in golden reference datasets or artificially generated imaging datasets that are usually defect-free. Thus, false negative and false positive defect detections can be prevented due to the simultaneous use of at least three imaging datasets.

In an example, at least the first imaging dataset 22, the second imaging dataset and the third imaging dataset comprise acquired imaging datasets obtained by applying an imaging apparatus, e.g., a SEM, a FIB-SEM an AFM, an aerial imaging system, e.g., equipped with a staring array sensor or a line-scanning sensor or a time-delayed integration sensor, an X-ray image, etc. Alternatively, the first imaging dataset 22, the second imaging dataset and/or the third imaging dataset can be acquired by a different imaging apparatus. Alternatively, the first imaging dataset 22, the second imaging dataset and/or the third imaging dataset can be artificially generated, e.g., by use of simulation or from designs of the integrated circuit patterns.

In an example, one or more of the imaging datasets are acquired imaging datasets comprising predominantly the same integrated circuit patterns as the portion of the object and are essentially defect-free, so-called “golden reference” datasets. In another example, one or more of the imaging datasets are obtained from designs comprising predominantly the same integrated circuit patterns as the portion of the object, e.g., from the design of the object itself or from different but similar designs. The appearance of the design can be modified to match the appearance of an acquired imaging dataset, e.g., by applying machine learning methods such as generative adversarial neural networks. In a preferred example, the first imaging dataset is an acquired imaging dataset of the portion of the object, the second imaging dataset is an acquired imaging dataset of another die of the same object comprising predominantly the same integrated circuit patterns, and the third imaging dataset is a golden reference dataset obtained from another object or a simulated dataset or a design dataset. In another preferred example, the first imaging dataset is an acquired imaging dataset, the second imaging dataset is obtained from a simulation or design, and the third imaging dataset is a golden reference dataset. In this case, rarely occurring defects in the golden reference dataset can be detected as well. In another preferred example, the first imaging dataset, the second imaging dataset and the third imaging dataset are acquired imaging datasets obtained from different portions of the same object comprising predominantly the same integrated circuit patterns. By using three acquired imaging datasets, additional information is available that can be used to increase the precision and recall of the defect detection method and the accuracy of the detected defects. This approach can be referred to as a die-to-die-to-die method for defect detection.

FIG. 5 illustrates an example of the steps of the computer implemented method 26 for defect detection according to an embodiment of the invention. A first imaging dataset 22 of a portion of an object comprising integrated circuit patterns in the form of a photolithography mask is obtained, e.g., using a SEM. The first imaging dataset 22 comprises a defect 24. In addition, a second imaging dataset 28 and a third imaging dataset 30 are obtained. The second imaging dataset 28 comprises an acquired first imaging dataset of a different die of the same object comprising predominantly the same integrated circuit patterns. The third imaging dataset 30 is obtained from a design of the photolithography mask. It can contain polygons that model the integrated circuit patterns. Additional imaging datasets, e.g., a fourth imaging dataset, or a fourth and a fifth imaging dataset, can be obtained as well. At least the first imaging dataset 22, the second imaging dataset 28 and the third imaging dataset 30 are processed jointly. The processing 32 can be carried out by some kind of defect detection method that derives defect information by comparing data directly obtained from at least the first imaging dataset 22, the second imaging dataset 28 and the third imaging dataset 30. In contrast, a defect detection algorithm that compares the first imaging dataset 22 to the second imaging dataset 28 in a first step and then compares the first imaging dataset 28 to the third imaging dataset 30 in a second step and detects defects based on the two results does not process the first imaging dataset 22, the second imaging dataset 28 and the third imaging dataset 30 jointly but sequentially.

In an example illustrated in FIG. 5, the processing comprises estimating one or more defect indicators 34, and defects 24 are detected using the one or more defect indicators 34. A defect indicator 34 indicates (potential) defects 24 in one or more imaging datasets, e.g., in the first imaging dataset 22, the second imaging dataset 28 or in the third imaging dataset 30, or in further imaging datasets, or in two or more imaging datasets together.

A defect indicator 34 can comprise a pixel-wise map 36 or a voxel-wise map that indicates for each pixel the presence or absence of a defect 24. In case of a 2D imaging dataset (e.g., an image or a stack of images), such a pixel-wise map 36 can be obtained by using a defect detection method that decides for each pixel in the dataset if a defect 24 is present or not, or that contains the likelihood for a defect 24 being present or absent. In case of a 3D dataset (a voxel grid), a voxel-wise map can be obtained by using a defect detection method that decides for each voxel in the dataset if a defect 24 is present or not, or that contains the likelihood for a defect 24 being present or absent. For example, a pixel-wise map 36 or a voxel-wise map can comprise a confidence map indicating the likelihood for the absence of a defect as shown in FIG. 5. Alternatively, the pixel-wise map 36 or voxel-wise map can comprise a defect probability map or a segmentation. A pixel-wise map 36 or voxel-wise map can, for example, be obtained using a segmentation algorithm, e.g., a machine learning method for defect segmentation.

Alternatively, a defect indicator 34 can comprise a list 38 of defect descriptions 40. Using lists 38 of defect descriptions 40 can be useful in case the accuracy of a pixel-wise map 36 is not required for further processing, or in case pixel-wise maps 36 are not available or cannot be generated by the defect detection method. A defect description 40 contains information about a (potential) defect 24. A defect description 40 can, for example, indicate the location of the defect and/or the shape of the defect and/or measurements of the defect and/or the appearance of the defect and/or the presence of the defect (“yes”/“no” or a probability for its presence of absence), etc. For example, a defect description 40 can comprise one or more coordinates of the defect 24, e.g., center coordinates, boundary coordinates, center of gravity coordinates, coordinates of a bounding box, or any other coordinates related to the defect 24. A defect description 40 can comprise a bounding box of any shape and size, e.g., a rectangular bounding box, a circular bounding box, an elliptical bounding box, a perimeter of the defect, a free-form bounding box, a 3D bounding box, etc. A defect description 40 can comprise a contour or a surface of the defect 24. A defect description can comprise one or more measurements of the defect 24 such as a length, a diameter, a radius, an area, a surface size, a contour length, etc. A defect description can comprise one or more appearance properties of the defect 24, e.g., an intensity or color distribution, the variance of the intensity or color distribution, edge locations, etc. A defect description 40 can comprise one or more shape attributes, e.g., shape descriptors, eccentricity, angles, lengths, ratios, curvature, Fourier descriptors, etc. A defect description 40 can also contain any further properties of the defect.

In an example, at least one defect indicator 34 is a probabilistic defect indicator. A probabilistic defect indicator comprises probabilistic information about defects 24. For example, a pixel-wise map 36 or voxel-wise map can comprise probabilities for the presence or absence of a defect 24. For example, a defect description 40 can comprise a probability for the presence or absence of the defect 24, or it can comprise a probability distribution over properties of the defect, e.g., over intensities, color values, locations, etc., or it can comprise moments of probability distributions over properties, e.g., a mean value, a variance, a kurtosis, or higher order moments, e.g., a mean intensity value or a color variance. For example, the two pixel-wise maps 36 in FIG. 5 contain probability values for the absence of a defect, i.e., confidence maps.

The one or more defect indicators 34 can all be of the same type, e.g., pixel-wise maps 36 or lists 38 of defect descriptions 40, or they can be of different types, e.g., one pixel-wise map 36 and two lists 38 of defect descriptions 40, etc.

In an example, at least one defect indicator 34 comprises a defect and a unique identifier of an imaging dataset that contains the defect. For example, a defect indicator 34 contains a list 38 of defect descriptions 40, and for at least one of the defect descriptions 40 the imaging dataset, that contains the defect the at least one defect description 40 refers to, is indicated by a unique identifier. For example, in case a defect description 40 refers to a defect in the second imaging dataset, the defect description 40 can contain the unique identifier “2”. Alternatively, the whole list of defect descriptions 40 can be associated with one or more unique identifiers of the imaging datasets the defects in the list originate from, e.g., a “1” and a “2” indicating the first imaging dataset 22 and the second imaging dataset 28. In case a defect indicator 34 comprises a pixel-wise map 36 or a voxel-wise map, single pixels or sets of pixels or single voxels or sets of voxels in the map can be associated with one or more unique identifiers of the one or more imaging dataset the pixel or voxel information is obtained from. In this way, defects are associated with the specific imaging datasets from which the defect information is obtained.

Using the one or more defect indicators 34, defects 24 can be detected. For example, in case a single defect indicator 34 is obtained after processing the first imaging dataset 22, the second imaging dataset 28 and the third imaging dataset 30, defects 24 can be extracted from the defect indicator 34, e.g., from a pixel-wise map 36, for example by thresholding a confidence or probability map, or by using the entries in a list 38 of defect descriptions 40. In case two or more defect indicators 34 are available for different input datasets, e.g., for the first imaging dataset 22 and the second imaging dataset 28 and/or the third imaging dataset 30, the defect indicators 34 can be processed together, combined or compared to take a qualified decision about the presence of a defect 24.

In an example, the processing 32 comprises estimating a defect indicator 34 for at least each of the first imaging dataset 22, the second imaging dataset 28 and the third imaging dataset 30. By comparing at least the defect indicators 34 of the first imaging dataset 22, the second imaging dataset 28 and the third imaging dataset 30, defects 24 can be detected with improved precision and recall. For example, potential defects 24 occurring in the defect indicator 34 of the first imaging dataset 22 but not in the defect indicator of the second imaging dataset 28 and the third imaging dataset 30 can be marked as defect 24 with high probability. On the other hand, potential defects 24 occurring in the defect indicator 34 of the second imaging dataset 28 or in the defect indicator 34 of the third imaging dataset 30 may indicate a false positive defect detection and may not be marked as a defect 24 in the other imaging datasets 22. Potential defects in defect indicators 34 of imaging datasets that are usually defect-free, e.g., golden reference datasets, artificially generated imaging datasets, etc., can indicate rare defects 24. Such defects, which usually lead to false positive defect detections in other imaging datasets, can be handled by processing three or more imaging datasets.

In FIG. 5, the defect indicator 34 in the form of a pixel-wise map 36 (a confidence map for the absence of a defect) for the first imaging dataset 22 indicates a low confidence at the location of the defect 24, since the integrated circuit patterns in the second imaging dataset 28 and in the third imaging dataset 30 do not correspond to the integrated circuit patterns in the first imaging dataset 22. The defect indicator 34 in the form of a list 38 of defect descriptions 40 comprises two defect descriptions D1 and D2 corresponding to defects 29 contained in the other die of the same object that is used as second imaging dataset 28. The defect descriptions 40 can, for example, contain the location of the center of the defect 24, the size of the defect, the shape of the defect, e.g., by using shape descriptors, properties of the defect such as intensity or color, intensity or color variance, etc. The defect indicator 34 in the form of a pixel-wise map 36 (a confidence map for the absence of a defect) for the third imaging dataset 30 indicates a high confidence.

Using the defect indicators 34 of the first imaging dataset 22, the second imaging dataset 28 and the third imaging dataset 30 together in an optional defect detection 42, defects 24 can be detected with improved recall and precision using the one or more defect indicators 34. The defect detection 42 can use some kind of defect detection method that detects defects from one or more defect indicators 34, e.g., thresholding, difference images, segmentation, contour detection, finding connected components, machine learning methods, etc. For example, the defects 29 in the second imaging dataset 28 can be recognized, e.g., by comparing the list of defect descriptions D1 and D2 to the pixel-wise map 36 of the third imaging dataset 30. The corresponding locations of potential defects 29 in the second imaging dataset 28 can, for example, be ignored in the first imaging dataset 22. The regions of low confidence in the pixel-wise map 36 of the first imaging dataset 22 can be marked as defect 24 with increased probability, since the list 38 of defect descriptions 40 does not contain an entry for this location and the pixel-wise map 36 of the third imaging dataset 30 exhibits a high confidence in this location. For example, a machine learning model can be trained to detect defects from the one or more defect descriptors 34. In case of a single defect descriptor 34 comprising a pixel-wise probability map, thresholding can be used to detect defects.

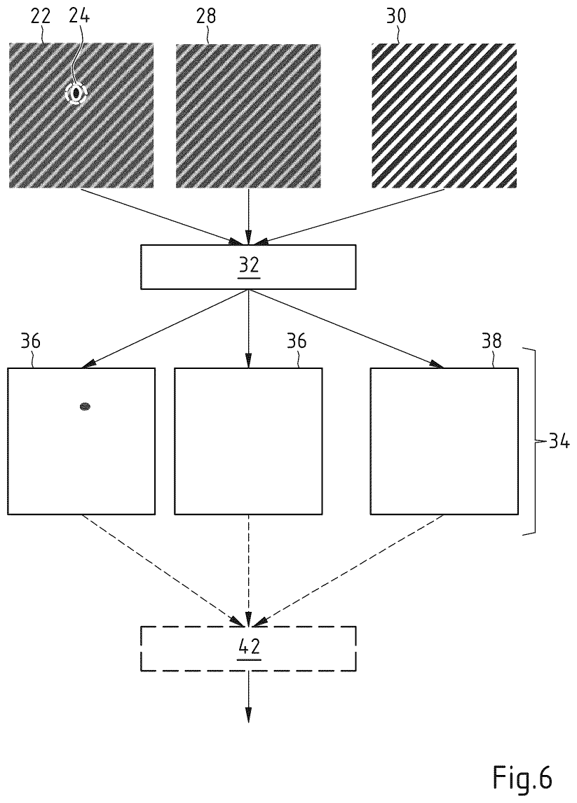

In an example illustrated in FIG. 6, the processing comprises estimating one or more defect indicators 34. As described for FIG. 5, defects 24 are detected by a defect detection 42 using the one or more defect indicators 34. The defect indicator 34 in the form of a pixel-wise map 36 (a confidence map for the absence of a defect) for the first imaging dataset 22 indicates a low confidence at the location of the defect 24, since the integrated circuit patterns in the second imaging dataset 28 and in the third imaging dataset 30 do not correspond to the integrated circuit patterns in the first imaging dataset 22. The pixel-wise maps 36 (confidence maps for the absence of a defect) for the second imaging dataset 28 and the third imaging dataset 30 indicate a high confidence. The second imaging dataset 28 and the third imaging dataset 30 exhibit corresponding integrated circuit patterns, while only the integrated circuit patterns of the first imaging dataset 22 differ in the location of the defect 24. The locations of low confidence in the pixel-wise map 34 of the first imaging dataset 22 can, thus, be marked as defect 24 with high probability, since both the second imaging dataset 28 and the third imaging dataset 30 exhibit a high confidence in these locations.

In an example, the one or more defect indicators 34 are filtered before detecting defects 24. For example, defect indicators 34 can be filtered using prior knowledge on the defects 24 of interest, e.g., concerning size, location, shape, material, or specific properties, etc. For example, defect indicators 34 can be filtered by removing potential defects below a predefined minimum size, in specific locations, within materials that are of no interest, with confidence values or defect probability values or average confidence or defect probability values above or below a predefined value, with intensity variances above a certain threshold, with atypical shapes, with properties lying outside confidence intervals established using predominantly defect-free imaging datasets, etc. By filtering defect indicators 34, false positive defect detections or irrelevant defect detections can be prevented.

Types of defect indicators 34, e.g., pixel-wise maps 36 or lists 38 of defect descriptions 40, can be transformed into other types of defect indicators. For example, a pixel-wise map 36 can be transformed to a list 38 of defect descriptions 40 by deriving, e.g., bounding boxes, center or boundary coordinates, sizes, locations or other properties of the defects 24 from the pixel-wise map 36. A list 38 of defect descriptions can be transformed to a pixel-wise map 36, e.g., by assigning specific values or probabilities to the pixels depending on the defect descriptions 40. For example, a value of 0 can be assigned to all pixels potentially belonging to a defect according to the defect descriptions 40, while a value of 1 is assigned to all pixels not belonging to any of the defect descriptions 40 or vice versa. For example, in case a defect description contains bounding boxes of defects, a value of 0 can be assigned to all pixels within the bounding boxes. Intermediate values, i.e., confidence values or defect probability values, can be assigned to pixels that may or may not belong to a defect, e.g., pixels close to the boundary of a bounding box or pixels close to a center coordinate of a defect.

In an example, defects 24 are detected by applying a function to the one or more defect indicators 34. Defect indicators 34 comprising lists 38 of defect descriptions 40 can be transformed to pixel-wise maps 36 before applying the function. The function can, for example, take the following form

$$f ( {i}_{1} ( x ) , {i}_{2} ( x ) , {i}_{3} ( x ) ) = {i}_{1} ( x ) \cdot max ( {i}_{2} ( x ) , {i}_{3} ( x ) ) ,$$

where i₁(x) indicates a value of a pixel-wise map 36 for the first imaging dataset 22 at a location x, i₂(x) indicates a value of a pixel-wise map 36 for the second imaging dataset 28 at location x and i₃(x) indicates a value of a pixel-wise map 36 for the third imaging dataset 30. Using this function, a confidence map of the first imaging dataset 22 can be modified by decreasing the confidence in case of a defect in both the second and the third imaging datasets 28, 30. Numerous other functions are conceivable such as the maximum or minimum of the at least three pixelwise maps, a mean of the pixel-wise maps 36

$$f ( {i}_{1} ( x ) , {i}_{2} ( x ) , {i}_{3} ( x ) ) = mean ( {i}_{1} ( x ) , {i}_{2} ( x ) , {i}_{3} ( x ) )$$

or a mean weighted by a defect likelihood of the imaging dataset generation method P₁, P₂, P₃

$$f ( {i}_{1} ( x ) , {i}_{2} ( x ) , {i}_{3} ( x ) ) = \frac{{i}_{1} ( x ) {p}_{1} + {i}_{2} ( x ) {p}_{2} + {i}_{3} ( x ) {p}_{3.}}{{p}_{1} + {p}_{2} + {p}_{3}}$$

In order to obtain defect indicators 34, various defect detection methods that jointly process at least the first imaging dataset 22, the second imaging dataset 28 and the third imaging dataset 30 can be applied, for example classical computer vision methods such as graph based methods, energy optimization methods, variational methods, partial differential equation (PDE) based methods, clustering methods, region growing methods, histogram based methods, etc. All of these methods can, for example, be used to jointly process at least the first imaging dataset 22, the second imaging dataset 28 and the third imaging dataset 30. To this end, for example, a joint segmentation of the at least three imaging datasets can be computed, e.g., by use of a histogram or color model of typical defects obtained from sample data or defined by a user. Graph based methods such as GrabCut or energy optimization methods such as variational methods minimize an objective function that usually contains a color-based term and a term penalizing the length of boundaries of segmented regions. By minimizing the objective function a segmentation of defects is computed for the at least three imaging datasets. On the other hand, machine learning methods can be used to jointly process at least the first imaging dataset 22, the second imaging dataset 28 and the third imaging dataset 30, such as support vector machines, decision trees, Bayes classifiers, clustering algorithms, neural networks, in particular deep neural networks, etc.

For example, to obtain pixel-wise maps 36 of the at least three imaging datasets, a machine learning model that is trained on essentially defect-free images in an unsupervised manner such as a one-class support vector machine, a multilayer perceptron with a single hidden layer, a codebook or an autoencoder can be used that use patches of the at least three imaging dataset as input. These methods learn a subspace of essentially defect-free image patches from training data. Based on a distance of an image patch to the learned subspace a decision can be taken if the image patch contains a defect or not, e.g., by using a threshold. Alternatively, supervised machine learning methods such as a deep encoder-decoder neural network, e.g., a U-Net, can be used that use an imaging dataset as input and generate a pixel-wise map 36, e.g., a segmentation or semantic segmentation, as output.

For example, to obtain a list 38 of defect descriptions 40, a bounding box detection method using, e.g., Center Net or YOLO (You Only Look Once) can be used that use the first imaging dataset 22, the second imaging dataset 28 and the third imaging dataset 30 as input. Center Net is a machine learning based object detector that represents objects by a single point at their bounding box center. Other properties such as object size, dimension, 3D extent, orientation, and pose are regressed directly from image features at the center location. Object detection is, thus, cast as a keypoint estimation problem. The input image is used as input of a fully convolutional network that generates a heatmap, whose peaks correspond to object centers. Image features at each peak predict the object bounding box. YOLO is a very fast machine learning based object detector that uses a fully convolutional neural network for bounding box prediction. The image is subdivided into grid cells, and for each grid cell a specified number of bounding boxes is predicted that can be larger than the grid cell. Bounding boxes are preserved based on their class probabilities and bounding box confidences. By using bounding box based object detectors, areas comprising a defect 24 can be quickly discriminated from defect-free areas.

In another example, defect indicators can be detected by comparing the integrated circuit patterns in the first imaging dataset 22, the second imaging dataset 28 and the third imaging dataset 30 and, potentially, further imaging datasets. In case the integrated circuit patterns are identical in the first imaging dataset 22 and at least one other imaging dataset, a high confidence can be assigned to the corresponding location in the first imaging dataset 22. In case the integrated circuit patterns in the first imaging dataset 22 differ from the integrated circuit patterns in all other or a substantial number of the other imaging datasets 28, 30, the likelihood for a defect can be increased in the corresponding location of the first imaging dataset 22. To detect potential defects in a golden reference, the integrated circuit patterns in the corresponding imaging dataset can be compared to the integrated circuit patterns in the other one or more imaging datasets, in particular to imaging datasets comprising a design of the integrated circuit patterns of the portion of the object. A defect in the golden reference is less likely the more of the one or more other imaging datasets contain the same integrated circuit patterns as the imaging dataset of the golden reference. In case the integrated circuit patterns in the imaging dataset of the golden reference are not identical to any of the integrated circuit patterns in the other one or more imaging datasets a defect is likely to be present in the golden reference.

In an example, the processing 32 comprises evaluating the likelihood of defects 24 from properties of the layout of the integrated circuit patterns in the portion of the object. A set of properties of layouts of integrated circuit patterns can be defined, and each property can be associated with a defect likelihood. The properties can, for example, comprise a minimum size, a maximum size, a color, a measure of regularity, a distance between integrated circuit patterns, a minimum distance between integrated circuit patterns, a measure of shape, e.g., convexity, a type of integrated circuit patterns such as memory or logic, etc. Each property can be associated with a defect likelihood, e.g., integrated circuit patterns that are irregular or very large or that do not abide by a minimum distance are likely to include a defect. A defect likelihood can then be assigned to the integrated circuit patterns in the portion of the object depending on the properties of integrated circuit patterns. These properties are either known for the portion of the object, indicated by a user or derived from one or more imaging datasets, e.g., from an imaging dataset containing a design of the portion of the object. In an example, the irregularity of the integrated circuit patterns in an imaging dataset, e.g., in a design dataset, can be used to define a confidence map for a defect. In case of irregular integrated circuit patterns a defect 24 is likely to be detected by a defect detection method, often leading to false positive defect detections. For example, a bridge, a line break or rounded edges form irregular integrated circuit patterns in an object. Irregular integrated circuit patterns can, for example, be detected by use of machine learning. For example, an autoencoder can be trained using only regular integrated circuit patterns. Then, by comparing an input dataset to its reconstruction by the autoencoder, irregular integrated circuit patterns cannot be fully reconstructed and cause deviations. From the deviations, irregular integrated circuit patterns can be detected in an imaging dataset, e.g., in a design dataset. Defects detected in these regions in another imaging dataset, e.g., in an acquired imaging dataset, can then be discarded as false positive defect detections.

The joint processing of at least the first imaging dataset 22, the second imaging dataset 28 and the third imaging dataset 30 can also be carried out by a machine learning model.

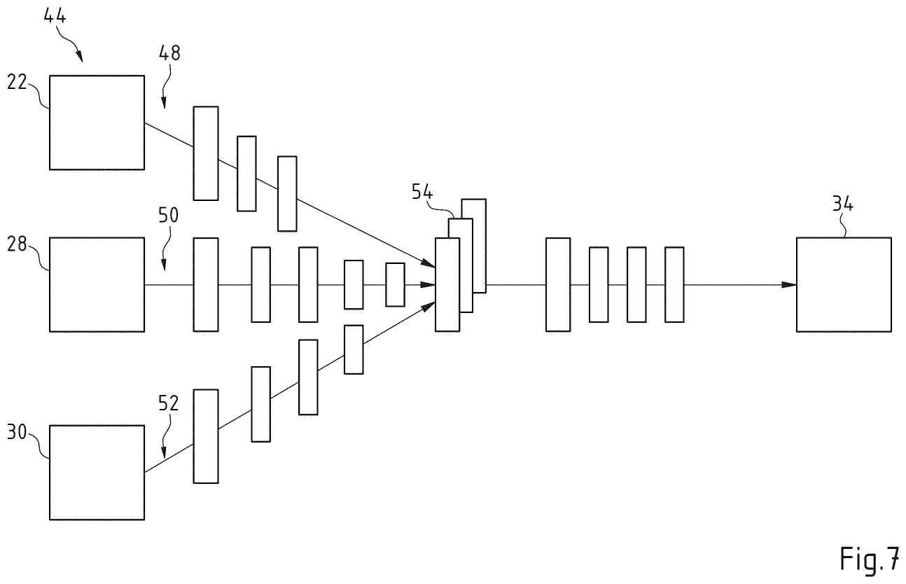

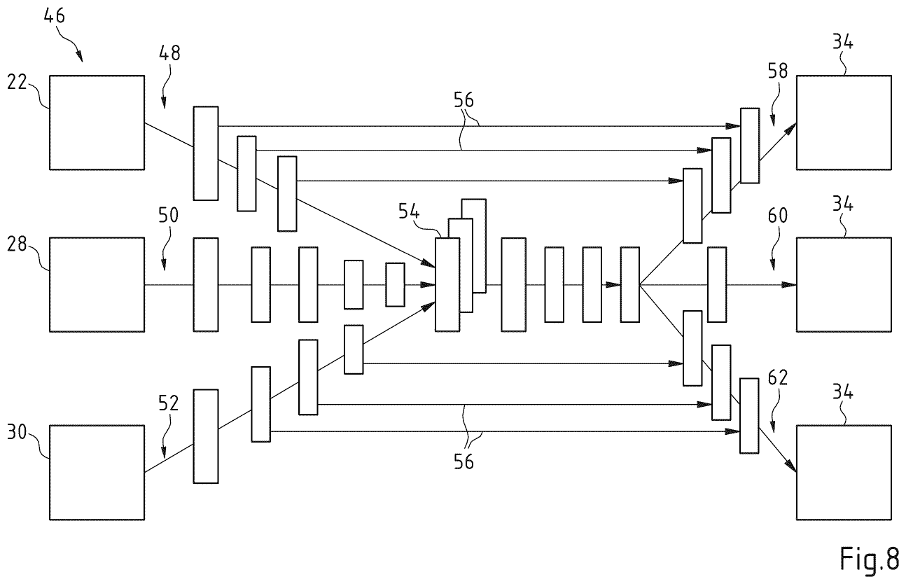

FIGS. 7 and 8 illustrate machine learning models in the form of neural networks 44, 46 that jointly process the first imaging dataset 22, the second imaging dataset 28 and the third imaging dataset 30. The neural networks 44, 46 comprise at least three input paths, wherein the first imaging dataset 22 is processed along a first input path 48, the second imaging dataset 28 is processed along a second input path 50 and the third imaging dataset 30 is processed along a third input path 52. The layers of the input paths 48, 50, 52 can differ in their number, type and/or size, etc. In this way, the at least three inputs, the first imaging dataset 22, the second imaging dataset 28 and the third imaging dataset 30 can be processed in different ways. It is also possible that the at least three inputs are processed in the same way by using identical input paths 48, 50, 52 with identical weights. The neural networks 44, 46 can have further input paths for processing further imaging datasets.

In the examples illustrated in FIGS. 7 and 8, the at least three input paths merge in a single merging layer 54. In some implementations, the first imaging dataset is a tensor of two or three dimensions a1×b1(× c1). The tensor is then used as input to the first input path. The second and third imaging datasets can be processed accordingly. Each layer transforms its input to a tensor of a potentially different size a×b×c. a×b refers to the spatial resolution of the output of the layer, c refers to the number of channels in the output. Preferably, the inputs of the merging layer are tensors of the same size that are concatenated to form a single tensor. To preserve the spatial information contained in the tensors (feature maps) that are the inputs of the merging layer 54 and are of size a×b×c, the tensors are concatenated to a single tensor of size a×b×3c. The merging layer 54, thus, receives the concatenated outputs of the three input paths as input. The size of the merging layer is, thus, the size of the combined outputs of the three input paths. The neural network is optimized using a backpropagation method or the AdamW optimizer. The neural network also comprises a subsequent processing path starting from the merging layer 54 and ending in the output layer that processes information of all three inputs. Thus, the neural networks 44, 46 both provide for at least three input datasets comprising the first imaging dataset 22, the second imaging dataset 28 and the third imaging dataset 30, that are processed by the three input paths 48, 50, 52. The neural networks 44, 46 also contain at least one step, the merging layer 54, that directly uses information of at least the first imaging dataset 22, the second imaging dataset 28 and the third imaging dataset 30 to derive defect information. Thus, the first imaging dataset 22, the second imaging dataset 28 and the third imaging dataset 30 are processed jointly.

The subsequent processing path between the merging layer 54 and the output layer can, for example, comprise an encoder that maps the inputs into a feature space. In another example, the subsequent processing path comprises a combination of an encoder, a bottleneck and a decoder. The subsequent processing path can comprise a decoder only. The subsequent processing path can comprise further operations such as convolutional layers, pooling layers, dropout layers, etc.

In FIG. 7, the subsequent processing path between the merging layer 54 and the output layer of the neural network 44 results in a single defect indicator 34, e.g., a pixel-wise map 36 such as a confidence map, a defect probability map or a segmentation of an imaging dataset 22, or a list 38 of defect descriptions 40, e.g., a list of bounding boxes indicating defects 24 or center coordinates of defects 24, etc., in one of the imaging datasets. The defect indicator 34 can comprise a unique identifier indicating the imaging dataset that comprises the defects 24. Alternatively, the subsequent processing path can generate a defect indicator 34 comprising at least three channels, such that each channel indicates defects in one of the imaging datasets. During training of the neural network, each channel can be compared to the annotated defects within each of the imaging datasets. To this end, the loss function can contain a difference measure of the computed channels and the annotated defects, e.g., an L2-norm. Using the defect indicator 34 defects can be detected, e.g., by thresholding a probability map or by extracting defect locations from a defect description 40, etc.

In FIG. 8, the subsequent processing path of the neural network 46 that starts at the merging layer 54 results in three defect indicators 34, e.g., a defect indicator 34 for the first imaging dataset 22, a defect indicator 34 for the second imaging dataset 28 and a defect indicator 34 for the third imaging dataset 30. Each defect indicator 34 is generated by a different output path 58, 60, 62, in particular by the output path 58, 60, 62 corresponding to the input path 48, 50, 52. In FIG. 8, the defect indicator 34 for the first imaging dataset 22 is generated by a first output path 58. The first output path 58 corresponds to the first input path 48. The defect indicator 34 generated by the first output path 58 indicates defects 24 in the first imaging dataset 22. The defect indicator 34 for the second imaging dataset 28 is generated by a second output path 60. The second output path 60 corresponds to the second input path 50. The defect indicator 34 generated by the second output path 60 indicates defects 24 in the second imaging dataset 28. The defect indicator 34 for the third imaging dataset 30 is generated by a third output path 62. The third output path 62 corresponds to the third input path 52. The defect indicator 34 generated by the third output path 62 indicates defects 24 in the third imaging dataset 30. The loss function for training of the neural network contains, for example, a difference measure of each defect indicator 34 computed by an output path and corresponding annotated defect indicators. Backpropagation or AdamW can be used for optimization of the parameters of the neural network. Optimization can be carried out for each input path and corresponding output path separately. Thus, the difference measure at the first output path is used to optimize the first output path, the common layers of the subsequent processing path and the first input path. The difference measure at the second output path is used to optimize the second output path, the common layers of the subsequent processing path and the second input path, and so on. Instead of a direct assignment of input paths to output paths, the defect indicators 34 can contain a unique identifier of the imaging dataset they are generated from. The defect indicators 34 can also comprise for each defect a unique identifier of an imaging dataset that contains the defect.

In an example illustrated in FIG. 8, the neural network comprises skip connections 56 connecting layers of an input path 48, 50, 52 with layers of an output path 58, 60, 62. A skip connection between a first layer and a second layer uses the output of the first layer as an additional input of the second layer. In this way, the output of the first layer “skips” the processing carried out by the layers between the first layer and the second layer. The matrix representing the output of the first layer is concatenated to the matrix representing the input of the second layer, thereby forming an input of a larger size. In particular, the skip connections 56 connect layers of an input path 48, 50, 52 with layers of the corresponding output path 58, 60, 62. For example, layers of the first input path 48 are connected to layers of the first output path 58, layers of the second input path 50 are connected to layers of the second output path 60 (not shown here), and layers of the third input path 52 are connected to layers of the third output path 62. By connecting input paths to output paths, information from the specific input path can be directly used by the output path, e.g., specific information about the first imaging dataset 22 contained in the first input path 48 can be directly used by the corresponding first output path 58 to generate the defect indicator 34 for the first imaging dataset 22, specific information about the second imaging dataset 28 contained in the second input path 50 can be directly used by the corresponding second output path 60 to generate the defect indicator 34 for the second imaging dataset 28, and/or specific information about the third imaging dataset 30 contained in the third input path 52 can be directly used by the corresponding third output path 62 to generate the defect indicator 34 for the third imaging dataset 22.

Furthermore, a skip connection 56 can connect a layer of an input path 48, 50, 52 to a layer of a non-corresponding output path 58, 60, 62, e.g., a layer of the first input path 48 to a layer of the second or third output path 60, 62. In this way, specific information about a dataset, e.g., about the first imaging dataset 22, can be used in one or more non-corresponding output paths, e.g., in the second and/or third output path 60, 62 to generate the defect indicator 34 for the second and/or third imaging dataset 28, 30, etc. The skip connections 56 are optional. They can be used to connect an arbitrary number of layers, but they can also be omitted, in particular for layers close to the merging layer 54.

In an example, the machine learning model is configured to process the input paths asynchronously. Asynchronously means that the processing of an input path can start as soon as the input dataset is available. For example, in case a second imaging dataset 28 is already available, but a first imaging dataset 22 and a third imaging dataset 30 is not yet available, the processing of the second input path 50 can already be carried out using the available second imaging dataset 28. As soon as the first imaging dataset 22 or the third imaging dataset 30 is available, the processing of the corresponding input path 48, 52 can be carried out as well. In case of a single merging layer 54 as shown in FIGS. 7 and 8, the asynchronous processing of input paths can be carried out up until the merging layer 54. The processing continues as soon as all results of the input paths are available.

In an example, at least one imaging dataset 22, 28, 30 comprises additional information on the likelihood of a defect 24 being present within the imaging dataset 22, 28, 30. The likelihood of a defect 24 being present in the imaging dataset 22, 28, 30 can, for example, be derived from the generation method of the imaging dataset 22, 28, 30. For example, an imaging dataset 22, 28, 30 acquired of the object comprising integrated circuit patterns can comprise defects 24 with a low likelihood, since defects 24 rarely occur in these objects. An imaging dataset 22, 28, 30 of an object that has been checked for defects (a golden reference) can still comprise defects 24, but with lower likelihood. A simulated imaging dataset or an imaging dataset obtained from a CAD file is usually defect-free and, thus, the likelihood of a defect 24 being present is close to 0. This kind of information can be used in the defect detection 42 in order to decide on the presence of a defect or not. For example, in case the first and the second imaging datasets 22, 28 contain the same or a similar defect, a defect 24 will probably be detected in the third imaging dataset 30 since it differs from the first imaging dataset 22 and from the second imaging dataset 28. In case, the defect likelihood in the third imaging dataset 30 is close to 0 but higher for the first imaging dataset 22 and for the second imaging dataset 28, the defect 24 may be correctly detected as present in the first imaging dataset 22 and in the second imaging dataset 24. In this way, the precision and recall of the defect detection method and the accuracy of the detected defects can be improved.

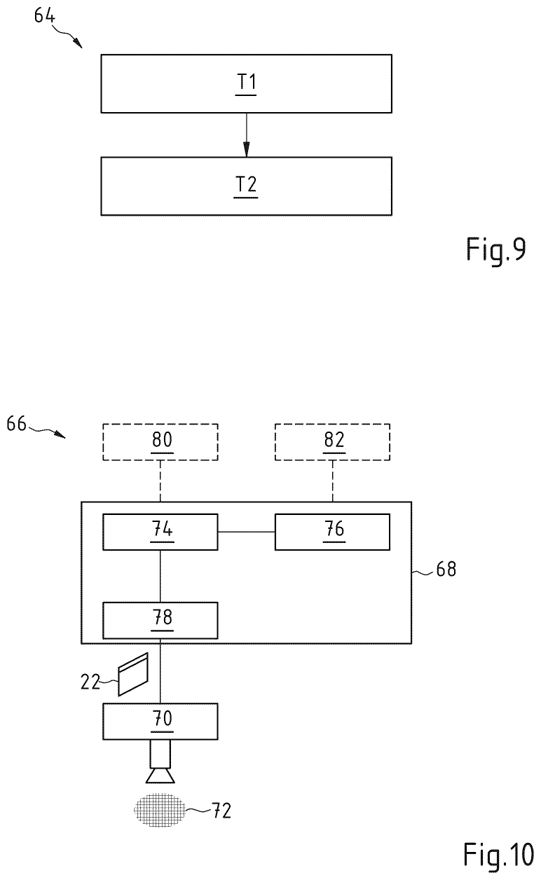

According to an embodiment of the invention illustrated in FIG. 9, a computer implemented method 64 for training a machine learning model for defect detection as described above comprises: providing training images of objects comprising integrated circuit patterns, the training images comprising at least triplets of first imaging datasets 22, second imaging datasets 28 and third imaging datasets 30 including annotated defects 24 in a step T1; and training the machine learning model using the provided training images by minimizing a loss function configured for defect detection in a step T2. The annotated defects can, for example, be obtained by using human annotators, simulated datasets or design datasets. The loss function can, for example, comprise a channel-wise binary cross-entropy loss function and/or a focal loss function comparing the defect indicator 34 to the annotated defects.

The annotated defects can be transformed into a ground truth defect indicator, for example, into a pixel-wise map 36, e.g., a confidence map, or into a list 38 of defect descriptions 40, e.g., bounding boxes. The ground truth defect indicator can then be compared to the defect indicator 34 in the loss function. In some implementations, a channel-wise binary cross-entropy loss function l(x) can be written at each pixel x using tᵢ(x) as ground truth defect indicator (1 or 0) for channel i at pixel x and pᵢ(x) as defect indicator computed by the neural network for channel i at pixel x:

$$l ( x ) = - {\sum }_{i = 1}^{C} - {t}_{i} ( x ) log ( {p}_{i} ( x ) ) - ( 1 - {t}_{i} ( x ) ) log ( 1 - {p}_{i} ( x ) )$$

The number of channels refers to the number of output images of the neural network, e.g., in case of multiple output paths of the neural network as in FIG. 8 each channel refers to one of the output paths. In case of a single output path C=1. A channel-wise binary cross-entropy focal loss can be written as follows:

$$l ( x ) = - {\sum }_{i = 1}^{C} - {( 1 - {p}_{i} )}^{γ} {t}_{i} ( x ) log ( {p}_{i} ( x ) ) - ( 1 - {t}_{i} ( x ) ) {p}_{i}^{γ} log ( 1 - {p}_{i} ( x ) )$$

e.g., for γ∈[0,5]. Here, γ increases the penalty for pixels that are mapped to values far away from the ground truth value. By minimizing the loss function the parameters of the neural network are optimized.

A system 66 for defect detection according to an embodiment of the invention illustrated in FIG. 10 comprises an imaging device 70 for obtaining one or more imaging datasets of a portion of an object 72 comprising integrated circuit patterns, and a data analysis device 68 comprising one or more processing devices 74 and one or more machine-readable hardware storage devices 76 comprising instructions that are executable by one or more processing devices 74 to perform operations comprising a computer implemented method 26 for defect detection as described above.

The system 66 can optionally comprise a database 80, e.g., for loading and/or saving first imaging datasets 22, second imaging datasets 28, third imaging datasets 30, training images, etc. The imaging device 70 for obtaining one or more imaging datasets of the object 72 comprising integrated circuit patterns can, for example, comprise a charged particle beam device, for example, a Helium ion microscope, a cross-beam device including FIB and SEM, an atomic force microscope or any charged particle imaging device, or an aerial image acquisition system. The imaging device 70 for obtaining one or more imaging datasets of the object 72 comprising integrated circuit patterns can provide a first imaging dataset 22 and/or a second imaging dataset 28 and/or a third imaging dataset 30 and/or further imaging datasets to the data analysis device 68. Alternatively, the first imaging dataset 22 and/or the second imaging dataset 28 and/or the third imaging dataset 30 and/or further imaging datasets can be loaded from a database or some memory device or from a cloud.

The data analysis device 68 includes one or more processors 74, e.g., implemented as a central processing unit (CPU) or graphics processing unit (GPU). The one or more processors 74 can receive the first imaging dataset 22 and/or the second imaging dataset 28 and/or the third imaging dataset 30 and/or further imaging datasets, via an interface 78. The one or more processors 74 can load program code from a hardware-storage device 76, e.g., program code for executing a computer implemented method 26 for detecting defects 24 according to an embodiment of the invention as described above. The one or more processors can also load a first imaging dataset 22 and/or a second imaging dataset 28 and/or a third imaging dataset 30 and/or further imaging datasets from the hardware-storage device 76. The one or more processors 74 can execute the program code.

The system 66 can optionally comprise a user interface 82, e.g., for monitoring the training progress of a machine learning model, for selecting training parameters, etc.

The methods disclosed herein can, for example, be used during research and development of objects comprising integrated circuit patterns or during high volume manufacturing of objects comprising integrated circuit patterns, or for process window qualification or enhancement. In addition, the methods disclosed herein can also be used for defect detection of X-ray first imaging datasets of objects comprising integrated circuit patterns, e.g., after packaging the semiconductor device for delivery.

In some implementations, after the defects are found using the methods and systems described above, the object 72 (e.g., a photolithography mask, a reticle, or a wafer) can be modified to repair or eliminate the defects. Repairing the defects can include, e.g., depositing materials on the object using a deposition process, or removing materials from the object using an etching process. Some defects can be repaired based on exposure with focused electron beams and adsorption of precursor molecules.

In some implementations, a repair device for repairing the defects on an object (e.g., a mask, a reticle, or a wafer) can be configured to perform an electron beam-induced etching and/or deposition on the object. The repair device can include, e.g. an electron source, which emits an electron beam that can be used to perform electron beam-induced etching or deposition on the object. The repair device can include mechanisms for deflecting, focusing and/or adapting the electron beam. The repair device can be configured such that the electron beam is able to be incident on a defined point of incidence on the object.

The repair device can include one or more containers for providing one or more deposition gases, which can be guided to the object via one or more appropriate gas lines. The repair device can also include one or more containers for providing one or more etching gases, which can be provided on the object via one or more appropriate gas lines. Further, the repair device can include one or more containers for providing one or more additive gases that can be supplied to be added to the one or more deposition gases and/or the one or more etching gases.

The repair device can include a user interface to allow an operator to, e.g., operate the repair device and/or read out data.

The repair device can include a computer unit configured to cause the repair device to perform one or more of the methods described herein, based at least in part on an execution of an appropriate computer program.

The repair device can also repair other types of objects having integrated circuit patterns.

In some implementations, the information about the defects serve as feedback to improve the process parameters of the manufacturing process, e.g., exposure time, focus, illumination, etc., For example, after the defects are identified from a first photolithography mask or first batch of photolithography masks, the process parameters of the manufacturing process are adjusted to reduce defects in a second mask or a second batch of masks.

In some implementations, a method for processing defects includes detecting at least one defect in an object using the method for defect detection described above; and modifying the object to at least one of reduce, repair, or remove the at least one defect.

For example, the object can include at least one of a photolithographic mask, a reticle, or a wafer.

For example, modifying the object can include at least one of (i) depositing one or more materials onto the object, (ii) removing one or more materials from the object, or (iii) locally modifying a property of the object.

For example, locally modifying a property of the object can include writing one or more pixels on the object to locally modify at least one of a density, a refractive index, a transparency, or a reflectivity of the object.

In some implementations, a method of processing defects includes: processing a first object using a manufacturing process that comprises at least one process parameter; detecting at least one defect in the first object using the method for defect detection described above; and modifying the manufacturing process based on information about the at least one defect in the first object that has been detected to reduce the number of defects or eliminate defects in a second object to be produced by the manufacturing process.

For example, the object can include at least one of a photolithographic mask, a reticle, or a wafer.

For example, modifying the manufacturing process can include modifying at least one of an exposure time, focus, or illumination of the manufacturing process.

In some implementations, a method for processing defects includes: processing a plurality of regions on a first object using a manufacturing process that comprises at least one process parameter, wherein different regions are processed using different process parameter values; applying the method for defect detection described above to each of the regions to obtain information about zero or more defects in the region; identifying, using a quality criterion or criteria, a first region among the regions based on information about the zero or more defects; identifying a first set of process parameter values that was used to process the first region; and applying the manufacturing process with the first set of process parameter values to process a second object.

For example, the object can include a photolithographic mask, a reticle, or a wafer, and the regions comprise dies on the mask, reticle, or wafer.

In some implementations, the data analysis device 68 can include one or more computers that include one or more data processors configured to execute one or more programs that include a plurality of instructions according to the principles described above. Each data processor can include one or more processor cores, and each processor core can include logic circuitry for processing data. For example, a data processor can include an arithmetic and logic unit (ALU), a control unit, and various registers. Each data processor can include cache memory. Each data processor can include a system-on-chip (SoC) that includes multiple processor cores, random access memory, graphics processing units, one or more controllers, and one or more communication modules. Each data processor can include millions or billions of transistors.

The methods described in this document can be carried out using one or more computing devices, which can include one or more data processors for processing data, one or more storage devices for storing data, and/or one or more computer programs including instructions that when executed by the one or more computing devices cause the one or more computing devices to carry out the method steps or processing steps. The one or more computing devices can include one or more input devices, such as a keyboard, a mouse, a touchpad, and/or a voice command input module, and one or more output devices, such as a display, and/or an audio speaker.

In some implementations, the one or more computing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment”, “according to an example” or “according to an aspect” in various places throughout this specification are not necessarily all referring to the same embodiment, example or aspect, but may. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

In summary, in a general aspect, a computer implemented method 26 comprises: obtaining a first imaging dataset 22 of a portion of an object 72 comprising integrated circuit patterns; obtaining at least a second imaging dataset 28 and a third imaging dataset 30 comprising predominantly the same integrated circuit patterns as the portion of the object 72; and jointly processing at least the first imaging dataset 22, the second imaging dataset 28 and the third imaging dataset 30 to detect defects 24. The invention also relates to a corresponding computer program, computer-readable medium and system for defect detection.

Reference number list

| | |
|---|---|
| 10, 10′ | Photolithography system |
| 12 | Light source |
| 14 | Photolithography mask |
| 16 | Illumination optics |
| 18 | Projection optics |
| 20 | Wafer |
| 22 | First imaging dataset |
| 24 | Defect |
| 26 | Computer implemented method |
| 28 | Second imaging dataset |
| 29 | Defect |
| 30 | Third imaging dataset |
| 32 | Processing |
| 34 | Defect indicator |
| 36 | Pixel-wise map |
| 38 | List |
| 40 | Defect description |
| 42 | Defect detection |
| 44, 46 | Neural network |
| 48 | First input path |
| 50 | Second input path |
| 52 | Third input path |
| 54 | Merging layer |
| 56 | Skip connection |
| 58 | First output path |
| 60 | Second output path |
| 62 | Third output path |
| 64 | Computer implemented method |
| 66 | System |
| 68 | Data analysis device |
| 70 | Imaging device |
| 72 | Object |
| 74 | Processing device |
| 76 | Hardware-storage device |
| 78 | Interface |
| 80 | Database |
| 82 | User interface |

What is claimed is:

1. A computer implemented method for defect detection comprising:
obtaining a first imaging dataset of a portion of an object comprising integrated circuit patterns;
obtaining at least a second imaging dataset and a third imaging dataset comprising predominantly the same integrated circuit patterns as the portion of the object; and
jointly processing at least the first imaging dataset, the second imaging dataset and the third imaging dataset to detect defects.

2. The method of claim 1, wherein the processing comprises estimating one or more defect indicators, and wherein defects are detected using the one or more defect indicators.

3. The method of claim 2, wherein at least one defect indicator comprises a pixel-wise map or a voxel-wise map.

4. The method of claim 2, wherein at least one defect indicator comprises a list of defect descriptions.

5. The method of claim 2, wherein at least one defect indicator is a probabilistic defect indicator.

6. The method of claim 2, wherein at least one defect indicator comprises a defect and a unique identifier of an imaging dataset that contains the defect.

7. The method of claim 2, wherein a defect indicator is obtained for at least each of the first imaging dataset, the second imaging dataset and the third imaging dataset.

8. The method of claim 7, wherein defects are detected by comparing at least the defect indicators for the first imaging dataset, the second imaging dataset and the third imaging dataset.

9. The method of claim 1, wherein at least the first imaging dataset, the second imaging dataset and the third imaging dataset are registered.

10. The method of claim 1, wherein the processing comprises evaluating the likelihood of defects from properties of the layout of the integrated circuit patterns in the portion of the object.

11. The method of claim 1, wherein at least the first imaging dataset, the second imaging dataset and the third imaging dataset are input datasets of a machine learning model.

12. The method of claim 11, wherein the machine learning model comprises a neural network with at least three input paths, wherein the first imaging dataset is processed along a first input path, the second imaging dataset is processed along a second input path and the third imaging dataset is processed along a third input path.

13. The method of claim 12, wherein the at least three input paths merge in a single merging layer.

14. The method of claim 12, wherein the neural network generates a defect indicator for at least each of the first imaging dataset, the second imaging dataset and the third imaging dataset.

15. The method of claim 14, wherein the neural network comprises at least three output paths, wherein each defect indicator is generated by a different output path.

16. The method of claim 15, wherein the neural network comprises skip connections each configured to connect a layer of an input path with a layer of an output path.

17. The method of claim 11, wherein the machine learning model is configured to process the input paths asynchronously.

18. The method of claim 11, wherein the first imaging dataset, the second imaging dataset and the third imaging dataset are registered using a machine learning model.

19. The method of claim 1, wherein the first imaging dataset, the second imaging dataset and the third imaging dataset are from the group comprising acquired imaging datasets, design datasets, simulated datasets.

20. The method of claim 1, wherein at least one imaging dataset comprises additional information on the likelihood of a defect being present within the imaging dataset.

21. A computer implemented method for training a machine learning model for defect detection of claim 11, the method comprising:
providing training images of objects comprising integrated circuit patterns, the training images comprising at least triplets of first imaging datasets, second imaging datasets and third imaging datasets including annotated defects; and
training the machine learning model using the provided training images by minimizing a loss function configured for defect detection.

22. A computer program comprising instructions which, when the program is executed by a computer, cause the computer to carry out the method of claim 1.

23. A computer-readable medium, on which a computer program executable by a computing device is stored, the computer program comprising code for executing the method of claim 1.

24. A system for defect detection comprises:
an imaging device configured to provide one or more imaging dataset of a portion of an object comprising integrated circuit patterns;
one or more processing devices; and
one or more machine-readable hardware storage devices comprising instructions that are executable by the one or more processing devices to apply the method for defect detection according to claim 1.
